(19) United States
(12) Patent Application Publication
(10) Pub. No.: US 2018/0071907 A1
(43) Pub. Date: Mar. 15, 2018

(54) MODULAR FLEX DRIVE SYSTEM WITH COMMUNICATIONS

(71) Applicant: APEX BRANDS, INC., Apex, NC (US)

(72) Inventor: Kevin Myhill, Lexington, SC (US)

(21) Appl. No.: 15/554,119

(22) PCT Filed: Mar. 11, 2016
(86) PCT No.: PCT/US2016/022032

§ 371 Date: Aug. 28, 2017

Related U.S. Application Data
(60) Provisional application No. 62/132,210, filed on Mar. 12, 2015.

(51) Int. Cl. B25F 5/02; B25F 3/00

(52) U.S. Cl. CPC B25F 5/02; H04B 3/54; B25F 3/00

(57) ABSTRACT

A power tool may include a modular controller, an end effector, and a multi-function cable. The modular controller may include a power unit and a motor. The motor may be powered by the power unit. The end effector may be physically separated from the modular controller. The multi-function cable may operably couple the end effector and the modular controller. The multi-function cable may include a flexible drive assembly and a communication link. The flexible drive assembly may be configured to transfer mechanical power from the motor to the end effector. The communication link may be configured to provide communication between the modular controller and the end effector.

### CROSS REFERENCE TO RELATED APPLICATION

This application claims priority to U.S. 62/132,210 filed Mar. 12, 2015, the entire contents of which are incorporated herein by reference.

### TECHNICAL FIELD

Example embodiments generally relate to power tools and, in particular, relate to systems and architectures for improving ergonomics and access capabilities of such tools.

### BACKGROUND

Power tools are commonly used across all aspects of industry and in the homes of consumers. Power tools are employed for multiple applications including, for example, drilling, tightening, sanding, and/or the like. Handheld power tools are often preferred, or even required, for jobs that require a high degree of freedom of movement or access to certain difficult to reach objects.

Handheld power tools may have a number of different power sources. In this regard, for example, compressed air, mains electric power or batteries form common power sources. The power sources enable robust tools with multiple corresponding different uses to be put into action by operators in a number of different contexts.

In some specific industries, such as, but not limited to the aerospace industry, the operation and use of power tools may be subject to particular constraints. The constraints may include constraints from an ergonomic perspective relative to size and weight. In some cases, constraints may be introduced from an access perspective relative to reaching a required area for operation. In some other cases, constraints may be introduced from a process control perspective to ensure that the correct tool is being used in the correct manner.

A typical handheld power tool is a fully self-contained unit with a motor and gearing to drive some sort of end effector for a specific application. As mentioned above, power for the tool may be provided via a power source such as an air supply, batteries or mains power. However, the motor and gearing that is powered by the power source is generally all provided in the same product or unit. As such, these self-contained units can, at times, begin to grow in size and weight or otherwise begin to have access problems. The unit may also tend to generate heat, cold, vibration, or noise that can be generated by the power train and transfer to the user's hand or the workpiece.

Accordingly, it may be desirable to continue to develop improved mechanisms by which to implement ergonomic hand tools that have good access and process control capabilities.

### BRIEF SUMMARY OF SOME EXAMPLES

Some example embodiments may enable the provision of a power tool that employs a different structure to enhance the power tools capabilities without compromising the power tool relative to the constraints described above. Some example embodiments may also provide a system in which such power tools may be employed in connection with process control equipment.

In an example embodiment, a power tool is provided. The tool may include a modular controller, an end effector, and a multi-function cable. The modular controller may include a power unit and a motor. The motor may be powered by the power unit. The end effector may be physically separated from the modular controller. The multi-function cable may operably couple the end effector and the modular controller. The multi-function cable may include a flexible drive assembly and a communication link. The flexible drive assembly may be configured to transfer mechanical power from the motor to the end effector. The communication link may be configured to provide communication between the modular controller and the end effector.

In another example embodiment, a multi-function cable is provided. The multi-function cable may operably couple an end effector and a modular controller of a power tool. The modular controller may include a power unit and a motor. The multi-function cable may include a flexible drive assembly configured to transfer mechanical power from the motor to the end effector, and a communication link configured to provide communication between the modular controller and the end effector.

In another example embodiment, a system for control of a power tool is provided. The system may include a line controller configured to communicate parameters associated with the power tool, a wireless access point configured to wirelessly communicate with the line controller, a modular controller including a power unit and a motor that is powered by the power unit, an end effector and a multi-function cable. The modular controller includes a communication module to support wireless communication between the wireless access point and the modular controller. The end effector is physically separated from the modular controller. The multi-function cable operably couples the end effector and the modular controller. The multi-function cable includes a flexible drive assembly configured to transfer mechanical power from the motor to the end effector, and a communication link configured to provide communication between the modular controller and the end effector.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a functional block diagram of a system that may be useful in connection with providing a system and power tool according to an example embodiment;

FIG. 2 illustrates a functional block diagram of a power tool according to an example embodiment; and

FIG. 3 illustrates the system of FIG. 1 employed in a particular context with interchangeable end effectors in accordance with an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

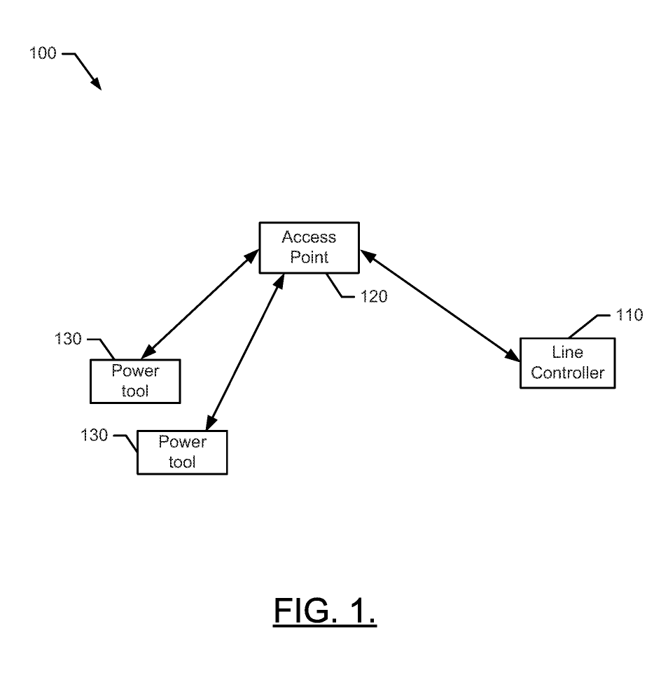

As indicated above, some example embodiments may relate to the provision of highly capable power tools that also have superior characteristics relative to performance and/or granting access to certain areas. Such power tools may also have superior ergonomic properties and allow for process controls to be effectively implemented. FIG. 1 illustrates a functional block diagram of a system that may be useful in connection with providing a system and power tool according to an example embodiment.

As shown in FIG. 1, a system 100 of an example embodiment may include a line controller 110, an access point 120 and one or more power tools 130. The line controller 110 may be a computer, server, or other processing circuitry that is configurable to communicate with the power tools 130 via the access point 120 to provide process controls. The line controller 110 may therefore include one or more processors and memory that may be configurable based on stored instructions or applications to direct operation of the power tools 130. As such, the line controller 110 may provide guidelines, safety limits, specific operating instructions, and/or the like to various ones of the power tools.

The access point 120 may be configured to interface with the line controller 110 and the power tools 130 via wireless communication. As such, for example, the access point 120 may be a component of or forming a wireless local area network (WLAN) or LAN for communication with other components of the network. The communications may be accomplished using Bluetooth, WiFi, HIPERLAN or other wavebands. Each of the access point 120, the power tools 130 and the line controller 110 may include a communications module having an antenna and corresponding transmit/receive circuitry for facilitating communication over the network. In some cases, the communications over the network may be secured with encryption and/or authentication techniques being employed by the communications modules at the respective components of the network.

FIG. 1 illustrates two power tools 130, but it should be appreciated that the system 100 may operate with one power tool or may operate with more than two power tools. Thus, two power tools are merely shown to exemplify the potential for multiplicity relative to the power tools 130 that could be employed with example embodiments. The power tools 130 may be configured to employ wireless communication with the line controller 110 on a one way (e.g., from the line controller 110 to the power tools 130) or two-way basis. As such, for example, in some cases, usage data for logging or activity tracking may be provided back to the line controller 110 from the power tools 130 responsive to operation of the power tools 130. Moreover, in some cases, the two-way communication may be employed for step-by-step or activity based interactive instruction provision that can be conducted on a real-time basis.

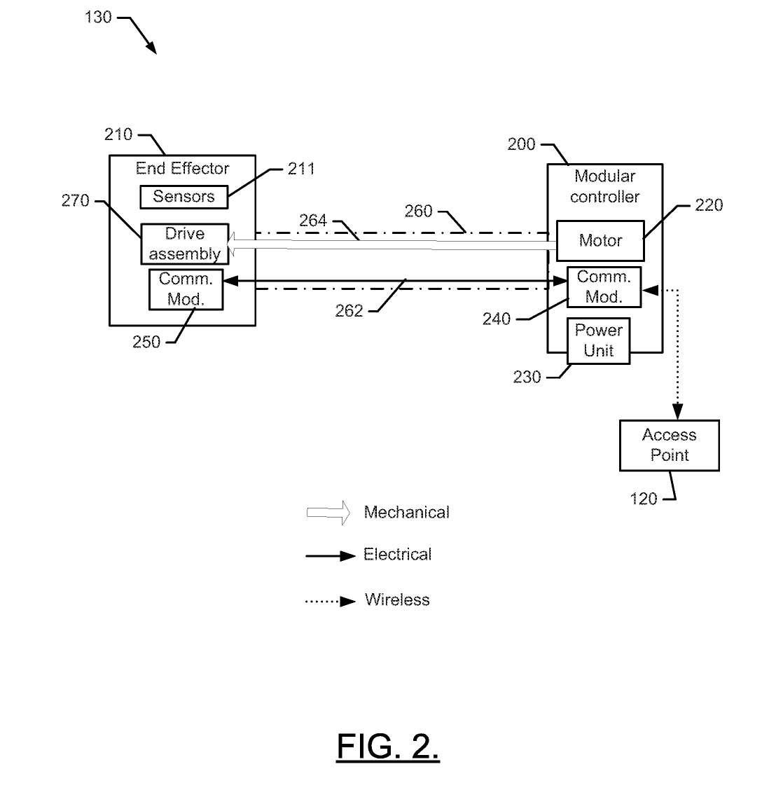

FIG. 2 illustrates a block diagram of components that may be employed in one of the power tools 130 in accordance with an example embodiment. As shown in FIG. 2, the power tool 130 may include a modular controller 200 and an end effector 210. The modular controller 200 may include a housing inside which a motor 220 may be provided. The motor 220 could be any type of motor. However, in an example embodiment, the motor 220 may be an AC or DC electric motor that is powered by an electric power source such as a battery or mains power. Thus, in an example embodiment, a power unit 230 from which the motor 220 is powered may be a removable and/or rechargeable battery pack housed within or attached to the housing of the modular controller 200. However, the power unit 230 could be a source of pressurized air or other power source in various other example embodiments.

The modular controller 200 may also include a communications module 240. The communications module 240 may include processing circuitry and corresponding communications equipment to enable the modular controller 200 to communicate with the access point 120 using wireless communication techniques (as described above). However, in some cases, the communications module 240 may also include processing circuitry and corresponding communications equipment to support communication with the end effector 210. Although not shown, the modular controller 200 may also include an LCD display for process parameter display, or for the display of other information associated with usage of the power tool 130.

The end effector 210 may include a corresponding communications module 250 to enable the end effector 210 to communicate with and/or receive instructions from the communications module 240 of the modular controller 200. In an example embodiment, the communication modules 240 and 250 may be operably coupled to each other via a multi-function cable 260. More particularly, a communication link 262 (e.g., a communication wire) may be provided within the multi-function cable 260 to connect the communication modules 240 and 250 to each other. However, it should be appreciated that in some embodiments, the communication modules 240 and 250 may be capable of wirelessly communicating with each other. As such, the communication link 262 could be embodied as a wireless link in some cases.

The communications exchanged between the end effector 210 and the modular controller 200 may include identification information that allows the end effector 210 to identify itself to the modular controller 200 (e.g., by function, tool type, or specific tool identifier). The modular controller 200 may access operating instructions correspondingly for the tool type or specific tool identifier of the end effector 210 and provide control signals or other operating instructions to the end effector 210 to control operation of the end effector 210. As such, the communications may allow defined applications to be conducted and/or controlled at the end effector 210 and may also allow the modular controller 200 to ensure that the correct end effector 210 is connected for the particular job to be accomplished. In some cases, each end effector may include an RFID tag or other identification component that can be read by a corresponding reader disposed at a portion of the multi-function cable 260 to communicate a tool identifier or other identification information back to the communication module 240 of the modular controller 200.

In some cases, usage data may also be communicated via the communication link 262. As such, for example, the end effector 210 may communicate a start signal to the modular controller 200 and the modular controller 200 may write usage data back to the end effector 210. In some cases, the end effector 210 includes one or more sensors 211, which may include strain gauges, thermocouples, Hall effect sensors, voltmeters, transducers, infrared sensors, RFID sensors, cameras, and/or the like for sensing physical characteristics about the end effector 210, its tool and components, its operation, and its local environment. These sensed characteristics may include, for example, torque applied to the tool or workpiece, temperature at the end effector, vibration of the end effector, angle of rotation of a spindle or other rotating end effector tool, the type of tool or bit attached to the end effector or multi-function cable, revolution count and rate of an end effector rotating tool or other end effector component, and images or other information about the workpiece being operator on. In some cases, the communication link 262 may additionally provide power to illuminate the end effector 210 or to provide illumination in the vicinity of the end effector 210. In an example embodiment, the illumination capability may include the provision of colored lights (e.g., red/green LEDs) that may be used for OK/NOK signaling related to the end effector 210. The communication link 262 may therefore provide a wired connection for power and/or information transfer. Moreover, if both functions are performed, they may be performed over separate wires or the same wire.

As shown in FIG. 2, the motor 220 may also be operably coupled to the end effector 210 via the multi-function cable 260. In this regard, the multi-function cable 260 may include a flexible drive assembly 264 to couple rotational power from the motor to a drive assembly 270 of the end effector 210. The drive assembly 270 may then act to perform the function for which the end effector 210 is configured. In various example embodiments, the end effector 210 may be a fastening tool, a material removal tool, an assembly tool, or the like. Thus, for example, the end effector 210 may be a spindle with attachments, a nutrunner, torque wrench, socket driver, drill, grinder, and/or the like. The drive assembly 270 may include gearing and/or other drive components that convert the rotational forces transmitted by the flexible drive assembly 264 to perform the corresponding function of the end effector 210 for fastening, material removal and/or assembly. In one embodiment, the end effector 210 is configured to be handheld by the user and may include a handle and a trigger for controlling operation of the end effector. In other embodiments, the end effector 210 is configured to be attached to a robot arm and operation is driven automatically or by user via modular controller 200 or by another controller in communication with the modular controller 200 and the robot arm via the access point 120.

The flexible drive assembly 264 may include a flexible drive shaft that is operably coupled to a drive shaft of the motor 220 (or a power train) to couple rotational energy from the drive shaft of the motor 220 to the drive assembly 270 of the end effector 210. If a power train is provided, the power train may include the motor 220 and a gear train (e.g., a planetary gear set) operably coupled to the motor 220. The coupling between the drive shaft of the motor 220 (or power train) and the flexible drive shaft may be may be provided by a coupler that is either permanent or removable. However, in any case, the coupler may be designed to prevent slippage. The flexible drive assembly 264 may therefore provide for mechanical coupling of rotational forces in either rotational direction through the multi-function cable 260 to allow the end effector 210 to perform a working function. The flexible drive assembly 264 may further include a flexible sleeve inside which the flexible drive shaft is allowed to rotate. As such, although the flexible sleeve may generally be bendable, the flexible sleeve otherwise remains fixed within the multi-function cable 260 while the flexible drive shaft is both bendable and rotatable inside the flexible sleeve. In some cases, the flexible sleeve and one or more electrical wires may therefore be provided within a single flexible casing that forms the exterior of the multi-function cable 260.

The multi-function cable 260 may be removably coupled to the end effector 210 to permit the end effector 210 to be exchanged for other end effectors to perform different tasks. The removable coupling may include a quick connect coupler that can be easily connected for non-slip mechanical power transfer, and can easily be disconnected to allow connection to other end effectors. The removable coupling may include mating for the electrical connections in addition to the non-slip mechanical power transfer connection.

As can be appreciated from FIG. 2, the multi-function cable 260 provides at least two functions. One such function is operable coupling of a mechanical nature, and a second function is operable coupling of some other nature (e.g., electrical coupling, optical coupling, or fluid coupling). The operable coupling of an electrical or optical nature may be at least for communication (one-way or two-way). However, in some cases the electrical operable coupling may further provide electric power as well. The fluid coupling may be to support pneumatic circuits or to provide coolant or lubrication from a reservoir in the modular controller to the workpiece (via an output within the end effector) or to the end effector's components (e.g., tool bits, cutters, grinders, gears, handles, or sensors, as the case may be). Meanwhile, the operable coupling of the mechanical nature is provided via a flexible drive shaft. Given that the power unit 230 may be embodied as a high capacity battery, the power unit 230 may account for a substantial portion of the overall size and weight of the power tool 130. Additionally, the motor 220 may add to the size and weight of the power tool 130.

By placing both the motor 220 and the power unit 230 in the modular controller 200, the modular controller 200 can be attached to the operator or at least not be borne by the hand of the operator that employs the end effector 210. The end effector 210 can therefore be designed with ergonomic efficiency and access in mind, with less weight and size restrictions as the end effector 210 may house some gearing, drive and/or communication components, but will not be burdened with weight and size limitations imposed by the motor 220 and the power unit 230. Example end effectors can therefore be designed with pistol grips, with angled actuators, crows feet, or any other desirable features and/or geometries.

In one example embodiment, a cross section of the multi-function cable 260 may resemble the number 8, with a mechanical cable running down one circle and a communication line running down the other circle. In other embodiments, the cross section includes more than two circles placed side to side for supporting the mechanical function, the communication function, and a fluid delivery function. In another example embodiment, the multi-function cable 260 may be a coaxial cable, with the communication lines disposed around the outside and the mechanical cable positioned inside of the communication lines. In other embodiments, the cross section of the multi-function cable 260 includes multiple concentric circles. For example the mechanical cable sheath may be surrounded by a second coaxial tube that communicates fluid, such as coolant, through the space between the outside of the mechanical cable sheath and the inside of the fluid tube. The communication lines may then surround the fluid tube in a coaxial arrangement with insulation or shielding therebetween. In some cases, the multi-function cable 260 may also include an internal counter or memory to monitor the number of flex shaft cycles for preventive maintenance purposes. The power tool 130 could be disabled in some cases in response to a determination that the number of cycles has exceeded a predetermined threshold (e.g., a maximum cycle count). In some cases, the multi-function cable 260 may also include one or more LEDs or other lighting elements to serve as status indicators for the power tool 130 and/or the multi-function cable 260 itself.

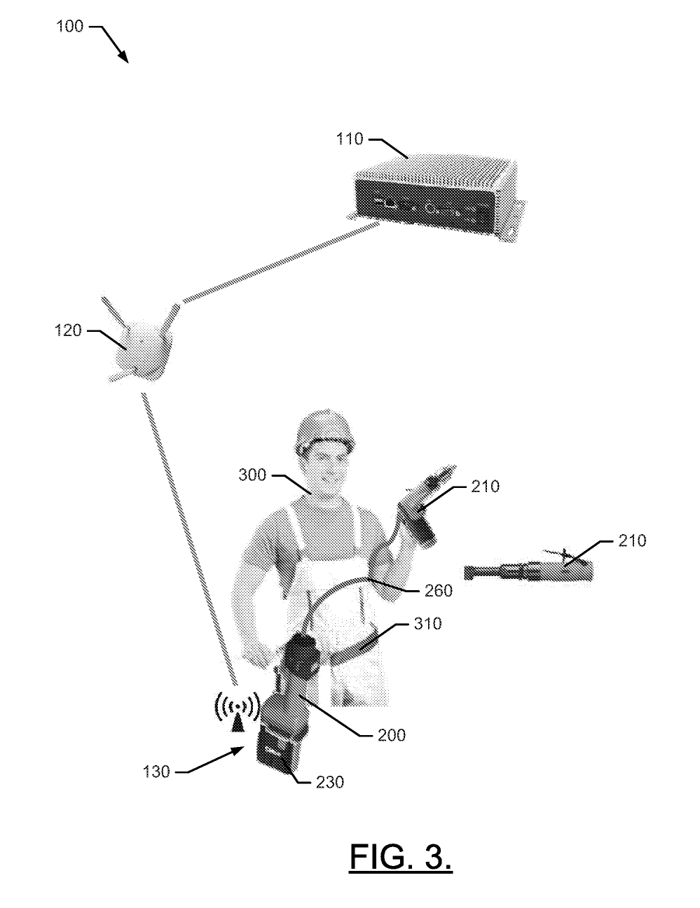

FIG. 3 illustrates one example embodiment of the system 100 of FIG. 1 in which an operator 300 holds the end effector 210 in one hand and the modular controller 200 is separately supported. Thus, for example, the modular controller 200 may be provided on a utility belt 310 of the operator 300 so that the weight of the modular controller 200 can be more easily supported by the operator 300. Although FIG. 3 shows the modular controller 200 being supported by the utility belt 310, it should be appreciated that the modular controller 200 could alternatively be provided on a backpack, or may rest on the floor or another surface while the operator 300 employs the end effector 210. FIG. 3 also shows an alternative end effector 210′ to illustrate that different end effectors can alternately be attached to and employed in connection with the modular controller 200.

As shown in FIG. 3, the line controller 110 may be in communication with the modular controller 200 via the access point 120. The separation of the modular controller 200 and the end effector 210 give the operator 300 greater mobility and also allows the end effector 210 to be relatively light and designed with ergonomics and access in mind, without significant constraint concerns associated with size and weight of power unit and motor components. Instead, simple gearing and drive components and other necessary actuators and geometrical features of the end effector 210 can provide limited constraint upon end effector design. Furthermore, by separating the modular controller 200 from the end effector 210 the heat, vibration, and noise generated by the motor 220, power unit 230, and/or communication module 240 is moved further from the end effector 210, the extended hand of the operator 300, and the work piece on which the end effector is operating. In some embodiments, this yields greater performance because the drill, fastener, grinder, or other end effector tool is held steadier and the power tool 130 imparts less heat and vibration into the workpiece, which may be important for some applications. In some embodiments where the end effector 210 includes one or more sensors sensing the local end effector environment, end effector state or performance, and/or workpiece characteristics, the sensor accuracy may be enhanced because heat, vibration, noise, and other interferences and influences of the motor 220, power unit 230, and/or communication module 240 can be physically separated from the local end effector environment during operation. In some embodiments, this power tool 130 structure yields further ergonomic benefits because the noise, heat, and/or vibration may be generated in a backpack or other form or modular controller 200 housing that is not held by the user's operating hand or arm where the noise, heat, and/or vibration may be better suppressed or controlled and where there are fewer constraints on size and weight. As such, in some embodiments the modular controller 200 includes fans and heat exchangers for dissipating hear and vibration and noise suppressors such as insulation and isolation mounting around the motor 220, power unit 230, and/or communication module 240.

The multi-function cable 260 provides the ability to employ an architecture that emphasizes freedom of design and mobility for the end effector 210 by separating the end effector 210 from the modular controller 200. Meanwhile, the multi-function cable 260 provides operable coupling between the end effector 210 from the modular controller 200 so that both mechanical power transfer and communication (potentially in both directions) can be accomplished via the multi-function cable 260. This architecture limits the size and weight of the tool to that which is easy and safe to handle in a person's hand without the addition of support arms/balancers that then limit the reach of the tools. Meanwhile, since a backpack can sometimes limit the motion of the person wearing the backpack, example embodiments may also allow the power unit to be provided into a relatively small modular controller that can be worn on a belt or holster to provide less mobility restriction.

Example embodiments may enable a variety of different power tools to function in respective different environments by performing a corresponding functional task and also collecting data related to the performance of the functional task via the multi-function cable 260. As an example, when the end effector 210 is embodied as a tightening assembly tool (e.g., fasteners, nutrunner, torque wrench, socket driver, etc.), the multi-function cable 260 may provide data that could be used for tool identification, socket identification, tool position/orientation determination, or the determination of various operating parameters such as speed, torque, vibration, sound, angle, temperature, etc.

In examples in which the end effector 210 is embodied as a drilling tool, the multi-function cable 260 may provide data that is used for tool identification, cutter identification, a determination of normality relative to a component surface, a determination of the amount of time a cutter has been used, a determination of the number of holes completed by the cutter, a determination of tool position/orientation, and/or the like. Alternatively or additionally, the multi-function cable 260 may provide data associated with determinations regarding various operating parameters such as speed, torque, thrust, vibration, feed, sound, temperature, etc.

In examples in which the end effector 210 is embodied as a material removal tool, the multi-function cable 260 may provide data that is used for tool identification, consumable identification, a determination of normality relative to a component surface, a determination of the amount of time a consumable has been used, tool position/orientation determination, and/or the like. Alternatively or additionally, the multi-function cable 260 may provide data associated with determinations regarding various operating parameters such as speed, torque, thrust, vibration, sound, temperature, etc.

Data collected via the multi-function cable 260 may be employed for diagnostic analysis on system or tool components for process control and monitoring. In some cases, component (e.g., end effector 210) health or consumable status may be monitored via the data for preventive maintenance and/or quality control.

In an example embodiment, data (including the example data described above) could be communicated wirelessly between the end effector 210 and the power unit 230, and the multi-function cable 260 may supply only power to the end effector 210 for any sensors and/or switches associated with the system 100 or components of the power tools 130. Alternatively, data (including the example data described above) could be communicated wirelessly between the end effector 210 and the power unit 230 with battery power onboard the end effector 210 to power the end effector 210 for any sensors and/or switches associated with the system 100 or components of the power tools 130.

Example embodiments may allow, among other things, wired power and data signal communication to be provided along with a flexible drive shaft coupling within a single cable. Such an embodiment would allow the tool itself to be lighter for either a human user or a robot to employ. End effectors may also be less expensive and the removal or reduction of heat, noise, vibration, etc., from the end effector may be improved (thereby yielding better tool performance and better tool ergonomics).

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits or solutions to problems are described herein, it should be appreciated that such advantages, benefits and/or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation.

1. A power tool comprising:
a modular controller including a power unit and a motor, the motor being powered by the power unit;
an end effector physically separated from the modular controller; and
a multi-function cable operably coupling the end effector and the modular controller,
wherein the multi-function cable comprises:
a flexible drive assembly configured to transfer mechanical power from the motor to the end effector; and
a communication link configured to provide communication between the modular controller and the end effector.

2. The power tool of claim 1, wherein the end effector comprises a selected end effector configured for execution of a drilling, material removal, assembly, or tightening function.

3. The power tool of claim 2, wherein the selected end effector communicates type information to the modular controller responsive to operable coupling of the end effector to the multi-function cable, the type information being associated with a function for which the selected end effector is configured.

4. The power tool of claim 1, wherein the communication link further comprises a wired connection for power provision to the end effector.

5. The power tool of claim 1, wherein the multi-function cable is removably coupled to the end effector.

6. The power tool of claim 1, wherein the communication link carries usage data information, process control information, or operational instructions between the end effector and the modular controller.

7. The power tool of claim 1, wherein the power unit comprises a battery and the motor comprises an electric motor.

8. The power tool of claim 1, wherein the modular controller is further configured to wirelessly communicate with a line controller via a wireless access point.

9. The power tool of claim 1, wherein the flexible drive assembly comprises a flexible drive shaft and a bendable sleeve fixed within the multi-function cable, and wherein the flexible drive shaft is rotatable within the bendable sleeve.

10. The power tool of claim 1, wherein the end effector comprises a handle that is configured to be held within a hand of a human user, and wherein the modular controller comprises a housing configured to be attached to a portion of the human user's body separate from the hand holding the handle of the end effector.

11. The power tool of claim 1, wherein the end effector comprises a sensor configured to sense usage data comprising an operating parameter of the power tool, a characteristic of the end effector's local environment, or a characteristic of a workpiece being operated on by the end effector, and wherein the communication link is configured to communicate the usage data to the modular controller.

12. The power tool of claim 1, wherein the multi-function cable further comprises a channel for carrying along the multi-function cable between the modular controller and the end effector.

13. A multi-function cable for operably coupling an end effector and a modular controller of a power tool, the modular controller including a power unit and a motor, the multi-function cable comprising:
a flexible drive assembly configured to transfer mechanical power from the motor to the end effector; and
a communication link configured to provide communication between the modular controller and the end effector.

14. (canceled)

15. (canceled)

16. The multi-function cable of claim 13, wherein the flexible drive assembly comprises a flexible drive shaft and a bendable sleeve fixed within the multi-function cable, and wherein the flexible drive shaft is rotatable within the bendable sleeve.

17. The multi-function cable of claim 16, wherein the communication link comprises one or more electrically conductive wires fixed within the multi-function cable besides and substantially parallel to the bendable sleeve or in a coaxial configuration with the bendable sleeve.

18. (canceled)

19. A system for control of a power tool, the system comprising:
a line controller configured to communicate parameters associated with the power tool;
a wireless access point configured to wirelessly communicate with the line controller;
a modular controller including a power unit and a motor, the motor being powered by the power unit, the modular controller comprising a communication module to support wireless communication between the wireless access point and the modular controller;
an end effector physically separated from the modular controller; and
a multi-function cable operably coupling the end effector and the modular controller,
wherein the multi-function cable comprises:
a flexible drive assembly configured to transfer mechanical power from the motor to the end effector; and
a communication link configured to provide communication between the modular controller and the end effector.

20. The system of claim 19, wherein the multi-function cable comprises a removable coupler configured to enable the multi-function cable to be removably coupled to the end effector to facilitate replacement of the end effector with an end effector of a different type.

21. The system of claim 19, wherein the power tool comprises a tightening assembly tool, and wherein the multi-function cable enables data to be communicated via the communication link, the data being associated with tool identification, socket identification, tool position/orientation determination, or a determination of operating parameters of the power tool.

22. The system of claim 19, wherein the power tool comprises a drilling tool, and wherein the multi-function cable enables data to be communicated via the communication link, the data being associated with tool identification, cutter identification, a determination of normality relative to a surface, a determination of an amount of time a cutter has been used, a determination of a number of holes completed by the cutter, a determination of tool position/orientation, or a determination of operating parameters of the power tool.

23. The system of claim 19, wherein the power tool comprises a material removal tool, and wherein the multi-function cable enables data to be communicated via the communication link, the data being associated with tool identification, consumable identification, a determination of normality relative to a surface, a determination of an amount of time a consumable has been used, tool position/orientation determination, or a determination of operating parameters of the power tool.

24. (canceled)

25. (canceled)
